(19) United States
(12) Patent Application Publication
(10) Pub. No.: US 2020/0083840 A1
(43) Pub. Date: Mar. 12, 2020

(54) System for Increasing Solar Panel Cooling Efficiency

(71) Applicants: Avo Babian, Sherman Oaks, CA (US); Anil Paryani, Cerritos, CA (US)

(72) Inventors: Avo Babian, Sherman Oaks, CA (US); Anil Paryani, Cerritos, CA (US)

(21) Appl. No.: 16/543,245

(22) Filed: Aug. 16, 2019

Related U.S. Application Data
(60) Provisional application No. 62/719,458, filed on Aug. 17, 2018.

(51) Int. Cl. H02S 40/42; E04H 4/12

(52) U.S. Cl. CPC H02S 40/425; E04H 4/129

(57) ABSTRACT

A system and method for cooling a solar panel to increase its efficiency is provided. The solar panel cooling system includes a plurality of heat transfer plates having central channels. Heat transfer pipes are disposed in the central channels and thermally bonded to the heat transfer plates. The heat transfer plates and heat transfer pipes are in turn thermally bonded to the back side of a solar panel. Water is then pumped through the heat transfer pipes and acts to cool the solar panel. The cool water is preferably pumped from a swimming pool and then returned to a swimming pool once heated by the solar panel in order to simultaneously cool the solar panel and heat the swimming pool.

### CROSS-REFERENCE TO RELATED APPLICATIONS

The present application claims the benefit of U.S. Provisional Application No. 62/719,458, filed Aug. 17, 2018, entitled “SYSTEM FOR INCREASING SOLAR PANEL COOLING EFFICIENCY,” which is hereby incorporated by reference in its entirety.

### BACKGROUND OF THE INVENTION

The present invention generally relates to a system for cooling solar panels. More particularly, the present invention relates to a solar panel cooling system that uses water recirculated from a pool.

Given a solar source outputting a fixed amount of energy, a Photovoltaic (PV) solar panel produces electric power at different rates dependent on the temperature of the PV. In general, solar panels produce less power as the temperature rises. Research shows that as the PV panels are cooled down, there is a dramatic, not a gradual, increase in power production, due to a “quantum solar effect”. The quantum effect is when electrons jump up to a higher energy state and release energy when they drop back down.

In general, the cooler a solar panel is, the greater electricity is generated by the same amount of light. Systems have been developed in the past to cool solar panels with water or air. One prior art technique is presented in an article entitled “Enhancing the performance of photovoltaic panels by water cooling”, by K. A. Moharrama, M. S. Abd-Elhadyb, H. A. Kandila, and H. El-Sherifa in Ain Shams Engineering Journal, Volume 4, Issue 4, December 2013, Pages 869-877.

However, due to one or more of cost, maintenance, lack of efficiency gains, or other reasons, prior art systems for cooling solar panels have failed to gain a significant market share in the solar PV market.

BRIEF SUMMARY OF THE INVENTION

One or more of the embodiments of the present invention provide a solar panel cooling system. The solar panel cooling system includes a plurality of heat transfer plates having central channels. Heat transfer pipes are disposed in the central channels and thermally bonded to the heat transfer plates. The heat transfer plates and heat transfer pipes are in turn thermally bonded to the back side of a solar panel. Water is then pumped through the heat transfer pipes and acts to cool the solar panel. The cool water is preferably pumped from a swimming pool and then returned to a swimming pool once heated by the solar panel in order to simultaneously cool the solar panel and heat the swimming pool.

### BRIEF DESCRIPTION OF THE DRAWINGS

FIG. 1 illustrates graphically the impact of the operation of an embodiment of the present invention.

FIG. 2 illustrates a heat transfer plate according to an embodiment of the present invention.

FIG. 3 illustrates a side view of the heat transfer plate of FIG. 2.

FIG. 4 illustrates an embodiment of the heat transfer plate of FIG. 2 with a heat transfer pipe installed in the central channel of the heat transfer plate.

FIG. 5 illustrates an embodiment of the heat transfer plate of FIG. 2 with a heat transfer pipe installed in the central channel of the heat transfer plate.

FIG. 6 illustrates a solar panel equipped with a cooling system according to an embodiment of the present invention.

FIG. 7 illustrates a cutaway view of the cooling system of FIG. 6.

FIG. 8 illustrates a closeup view of the heat transfer pipes and heat transfer pipe input apertures disposed along one side of the solar panel housing near the cool water delivery pipe.

FIG. 9 illustrates a closeup view of the heat transfer pipes and heat transfer pipe output apertures disposed along one side of the solar panel housing near the warm water removal pipe.

FIG. 10 illustrates an embodiment of a system for increasing solar panel cooling efficiency according to an embodiment of the present invention.

### DETAILED DESCRIPTION OF THE INVENTION

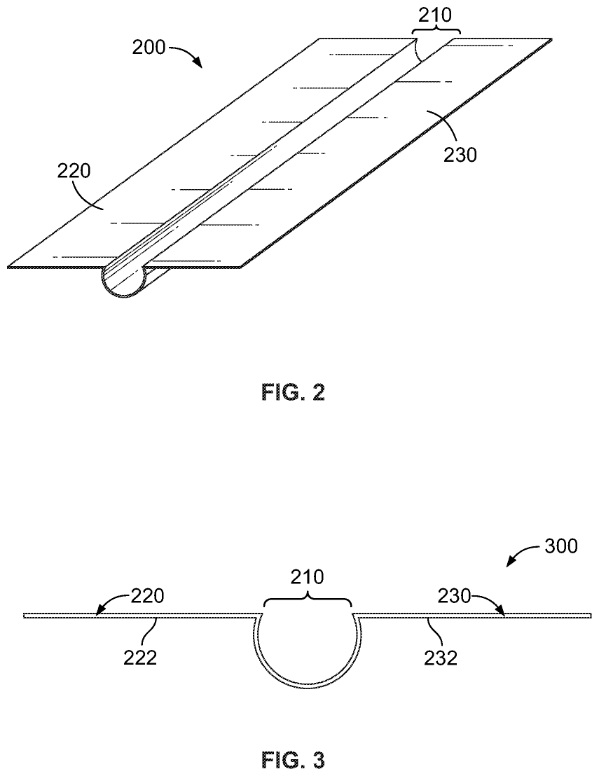

FIG. 2 illustrates a heat transfer plate 200 according to an embodiment of the present invention. As shown in FIG. 2, the heat transfer plate 200 includes a central channel 210 located substantially along the midline of the heat transfer plate 200. Along either side of the central channel 210 extend heat transfer surfaces 220, 230. In one embodiment, the central channel 210 is known as the Omega channel because the general shape of the heat transfer plate including the central channel 210 and the heat transfer surfaces 220, 230 appears somewhat similar to the Greek letter Omega.

FIG. 3 illustrates a side view 300 of the heat transfer plate 200 of FIG. 2. FIG. 3 also shows the central channel 210 and heat transfer surfaces 220, 230. Additionally, for each of the heat transfer surfaces 220, 230, the solar panel side 222, 232 of the heat transfer surfaces is identified. As described below, the solar panel side 222, 232 will be in adhesive thermal contact with the solar panel.

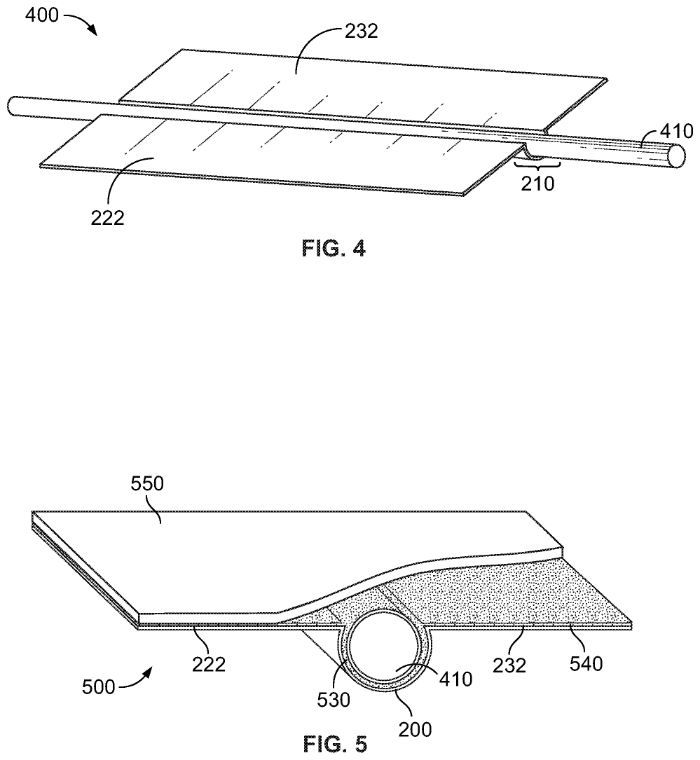

FIG. 4 illustrates an embodiment 400 of the heat transfer plate 200 of FIG. 2 with a heat transfer pipe 410 installed in the central channel 210 of the heat transfer plate 200.

FIG. 5 illustrates an embodiment 500 of the heat transfer plate 200 of FIG. 2 with a heat transfer pipe 410 installed in the central channel 210 of the heat transfer plate 200. As shown in FIG. 5, central channel thermally conductive epoxy 530 has been positioned in the central channel 210 between the heat transfer plate 200 and the heat transfer pipe 410 in order to provide a thermal connection between the heat transfer plate 200 and the heat transfer pipe 410. Additionally, solar panel thermally conductive epoxy 540 is positioned between the solar panel sides 222, 232 of the heat transfer surfaces 220, 230 and the rear of a solar panel 550 in order to provide a thermal connection between the heat transfer surfaces 220, 230 and the solar panel 550.

The central channel thermally conductive epoxy 530 fixes the heat transfer pipe 410 in the central channel 210. Similarly, the solar panel thermally conductive epoxy 540 adheres the heat transfer plate 200 to the back of the solar panel 550. Consequently, the heat transfer plate 200 is in thermal communication with the heat transfer pipe 410 and the solar panel 550. Thus, inducing cool water through the heat transfer pipe 410 allows for the solar panel 550 to be cooled by allowing thermal transfer to take place between the cool water and the solar panel 550.

In one embodiment, the heat transfer plate may be composed of a metal such as aluminum. In one embodiment, the thermal epoxy may be completely and thinly coated on the heat transfer plate so that there is no exposed aluminum.

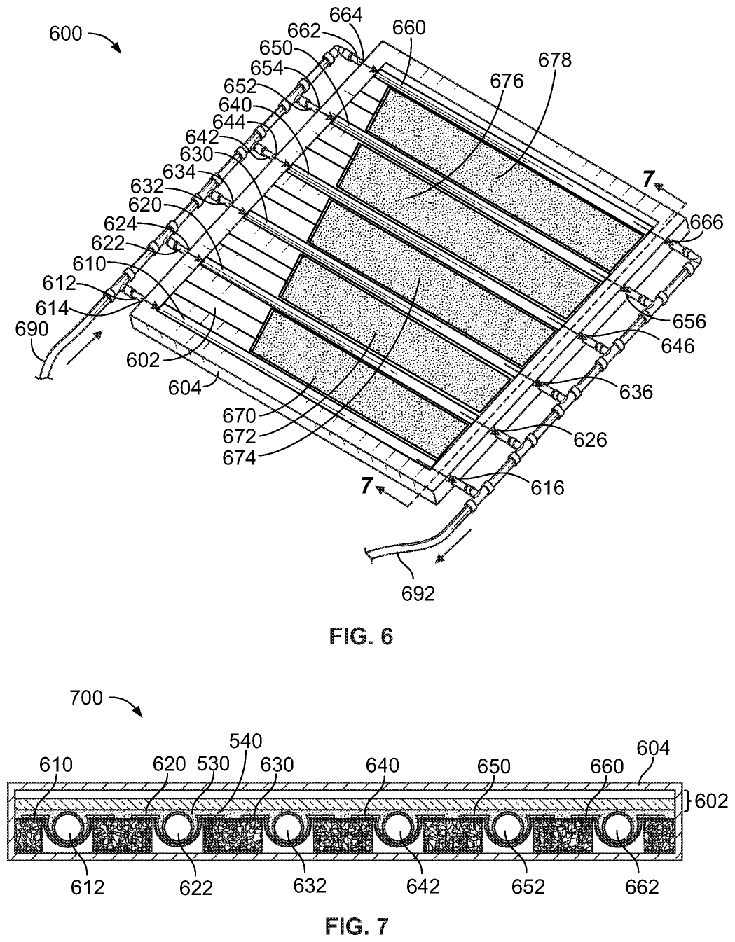

FIG. 6 illustrates a solar panel equipped with a cooling system 600 according to an embodiment of the present invention. The solar panel equipped with a cooling system 600 includes a solar panel 602 including a solar panel housing 604. As shown in FIG. 6, six heat transfer plates 610, 620, 630, 640, 650, and 660 have been adhered to the back side of the solar panel 602. Each heat transfer plate includes a central channel having an installed heat transfer pipe 612, 622, 632, 642, 652, and 662. Each heat transfer pipe 612, 622, 632, 642, 652, and 662 is connected to a cool water inlet receiving cool water from a cool water delivery pipe 690. Similarly, each heat transfer pipe 612, 622, 632, 642, 652, and 662 is connected to a warm water outlet delivering warm water to a warm water removal pipe 692.

In operation, cool water passes from the cool water delivery pipe 690 through the cool water inlets into each heat transfer pipe 612, 622, 632, 642, 652, and 662. As mentioned above, each heat transfer pipe 612, 622, 632, 642, 652, and 662 has been fixed, using thermally conductive epoxy, in the central channel of a heat transfer plate 610, 620, 630, 640, 650, and 660. Each of the heat transfer plates 610, 620, 630, 640, 650, and 660 have in turn been affixed, using thermally conductive epoxy, to the back of the solar panel 602. Thus, water flowing through the cool water delivery pipe 690 is in thermal communication with the solar panel due to the thermal communication between the water, heat transfer pipe, central channel thermally conductive epoxy, heat transfer plates, solar panel thermally conductive epoxy, and the back of the solar panel 602 itself.

Cool water passing through the heat transfer pipes 612, 622, 632, 642, 652, and 662 is thus warmed by the heat of the solar panel. Conversely, the solar panel is cooled by the transfer of heat from the solar panel to the heat transfer pipes 612, 622, 632, 642, 652, and 662. At the outlet of the heat transfer pipes 612, 622, 632, 642, 652, and 662, water that has been warmed due to thermal communication with the solar panel is passed to the warm water removal pipe 692 for removal from the cooling system 600.

As shown in FIG. 6, in one embodiment the cooling system 600 is installed in a solar panel housing 604 that includes the solar panel 602. The photovoltaic cells of the solar panel are installed on the other side of the solar panel housing 604 from the heat transfer pipes 612, 622, 632, 642, 652, and 662 and are not shown in FIG. 6. The solar panel housing is preferably composed of a rigid capable of outdoor installation, such as aluminum. As shown in FIG. 6, the solar panel housing 604 includes six heat transfer pipe input apertures 614, 624, 634, 644, 654, and 664 disposed along one side of the solar panel housing 604 near the cool water delivery pipe 690. The solar panel housing 604 also includes six heat transfer pipe output apertures 616, 626, 636, 646, 656, and 666 disposed along one side of the solar panel housing 604 near the warm water removal pipe 692.

Additionally, insulating panels 670, 672, 674, 676, and 678 are shown in cut-away view in FIG. 6 so that the heat transfer plates 610, 620, 630, 640, 650, and 660 may also be shown. The insulating panels 670, 672, 674, 676, and 678 are positioned inside the solar panel housing 604 and engage with the solar panel housing 604 at panel edges hear the cool water delivery pipe 690 and warm water removal pipe 692. The insulating panels 670, 672, 674, 676, and 678 form a thermal barrier between the heat transfer surfaces of the heat transfer plates 610, 620, 630, 640, 650, and 660 and the surrounding atmosphere. The insulating panels 670, 672, 674, 676, and 678 thus improve the efficiency of the thermal communication between the cool water flowing through the heat transfer pipes 612, 622, 632, 642, 652, and 662 and the solar panel 602 by reducing thermal transfer between the heat transfer pipes 612, 622, 632, 642, 652, and 662 and the surrounding atmosphere.

Further, although the exemplary embodiment of FIG. 6 illustrates a cooling system 600 having six heat transfer plates and heat transfer pipes, a greater or lesser number of heat transfer plates and/or heat transfer pipes may be employed.

FIG. 7 illustrates a cutaway view 700 of the cooling system 600 of FIG. 6. FIG. 7 shows the solar panel 602, solar panel housing 604, heat transfer pipes 612, 622, 632, 642, 652, and 662, and heat transfer plates 610, 620, 630, 640, 650, and 660. As further shown, each of the each of the heat transfer pipes 612, 622, 632, 642, 652, and 662 is positioned in the central channel of the heat transfer plates 610, 620, 630, 640, 650, and 660. The central channel thermally conductive epoxy 530 has been placed between the heat transfer pipes 612, 622, 632, 642, 652, and 662 and heat transfer plates 610, 620, 630, 640, 650, and 660 to allow for thermal communication.

Further, the solar panel thermally conductive epoxy 540 is shown disposed between the heat transfer surfaces of the heat transfer plates 610, 620, 630, 640, 650, and 660 and the rear face of the solar panel 604.

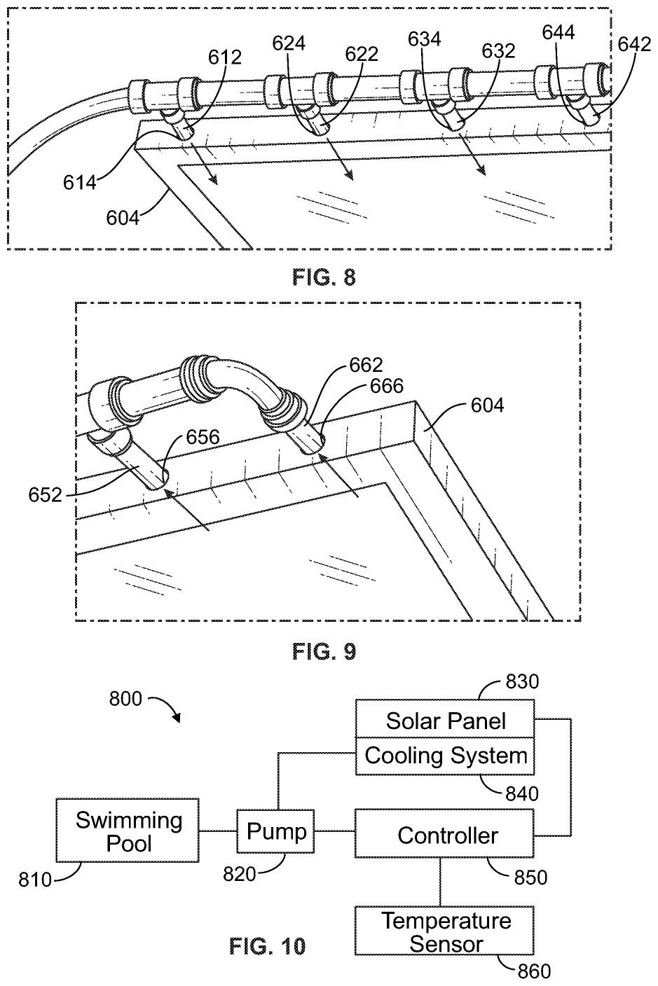

FIG. 8 illustrates a closeup view of the heat transfer pipes 612, 622, 632, and 642 and heat transfer pipe input apertures 614, 624, 634, and 644 disposed along one side of the solar panel housing 604 near the cool water delivery pipe 690.

FIG. 9 illustrates a closeup view of the heat transfer pipes 652 and 662 and heat transfer pipe output apertures 656 and 666 disposed along one side of the solar panel housing 604 near the warm water removal pipe 692.

FIG. 10 illustrates an embodiment 800 of a system for increasing solar panel cooling efficiency according to an embodiment of the present invention. FIG. 10 includes a swimming pool 810, a pump 820, a solar panel 830 with attached cooling system 840, a controller 850, and a temperature sensor 860. The cooling system 840 is similar to the cooling system 600 of FIG. 6.

In operation, cool water is transferred from the swimming pool 810 to the cool water delivery pipe 690 of the cooling system 840 by the pump 820. The pump 820 is also responsible for transferring warmed water from the warm water removal pipe 692 of the cooling system 840 to the swimming pool 810. The swimming pool 810 typically contains water that is at a temperature less than the ambient atmospheric temperature and is almost always considerably less than the temperature of the solar panel 830 when the solar panel 830 is being irradiated by sunlight.

As mentioned above the water that is pumped from the swimming pool 810 passes through the heat transfer pipes 612, 622, 632, 642, 652, and 662 of the cooling system 840 which are in thermal communication with the solar panel 830. Consequently, thermal communication takes place between the water in the heat transfer pipes 612, 622, 632, 642, 652, and 662 and the solar panel, which acts to warm the water and to cool the solar panels.

The pump 820 is under the control of the controller 850 which determined when to turn the pump 820 or pumps on or off based on preset temperature trigger points. The controller 850 receives temperature information from the temperature sensor 860, compares the temperature information to the preset temperature trigger points, and then turns the pump 820 on or off in response. In one example, when the temperature information is greater than a 100 deg F., the controller 850 may cause the pumps 820 tp begin pumping water to the cooling system 840.

In one embodiment, standard automotive grade pumps may be used for the pump 820. Not only are automotive grade systems low cost, but they are extremely durable. Alternatively, industrial pumps may also be used. The advantage of the industrial pump is that a relatively higher 12V power supply may be avoided and some efficiency may be gained since it is operating at a higher voltage.

In one or more embodiments of the present system, the flow rate desired is relatively modest. In one embodiment, a pump that may provide between 5 to 10 L per minute may be used.

The controller 850 is designed to drive the water pump drive 820, and in one embodiment using switched alternating current (AC) or switched 12V. The input to the controller 850 provided by the temperature sensor 860 may be a single temperature measurement of a single panel in the system or a cold plate, or may be a measurement of multiple solar panels or an ambient temperature measurement. In one embodiment, the temperature sensor 860 is installed on one of the cold plates for ease of installation. Preferably, the temperature sensor 860 is a thermistor that is bonded to the cold plate using potting material or notched in the cold plate with tabs. Thermocouples or RTDs may also be used to measure temperature.

A microprocessor in the controller may be used to read the thermistor using an analog-to-digital (A/D) converter. Alternatively, an analog comparator with hysteresis may be also used.

In one embodiment, the controller may employ a control method wherein if the temperature of the cold plate is greater than a preset value, such as 40 deg C. for example, the one or more of the water pumps are switched on. When the temperature falls below a preset value, such as 30 deg C. for example, the pumps may be turned off.

In one embodiment, the controller 850 is powered by power received from the solar panel 830. This way if the solar panel 830 is not producing any electricity, but the temperature detected by the temperature sensor 860 is above the preset value (such as on a warm night), the pumps 820 will not be initiated because cooling of the solar panel

830 cannot produce any more electricity because it is currently night. In this embodiment, it may be preferable to use a 12V motor and pump.

Alternatively, if the pool owner desires heating of the pool even at night, the pumps and/or controller may be supplied with AC power from the utility power grid. In this embodiment, the controller has a very low dark current to not consume energy when not in use.

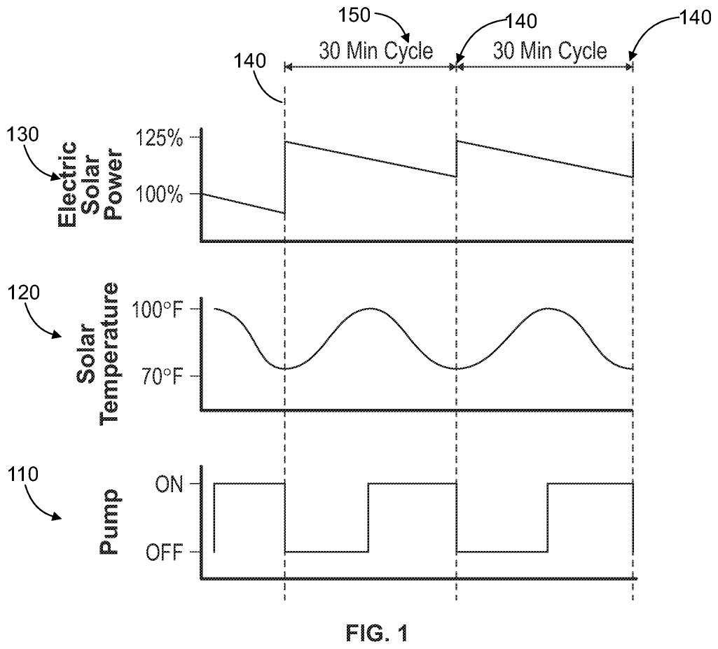

FIG. 1 illustrates graphically the impact of the operation of an embodiment of the present invention. FIG. 1 includes a pump on/off graph 110, a temperature of solar panel graph 120, and an electrical solar power graph 130. The pump on/off graph 110 illustrates the timing of the controller 850 turning on the pump 820, as well as an exemplary duty cycle of the pump 820. As discussed above, the pump 820 causes cold water to flow from the swimming pool 810 to the cooling system 840, thus cooling the solar panel 830 and for warm water to be returned to the swimming pool 810. As shown in FIG. 1, the pump 820 is using an exemplary 30-minute duty cycle 150. As discussed herein, alternative duty cycles may be employed, both duty cycles based on timing and duty cycles based on temperature detection from a temperature sensor.

The temperature of solar panel graph 120 illustrates the temperature of the solar panel 830 over time. The impact on the temperature of the solar panel provided by the cooling system 840 can be seen.

The electrical solar power graph 130 illustrates the electrical power produced by the solar panel 830 over time. Further, as mentioned above, solar panels produce more power as the temperature is lowered, especially when the quantum solar effect takes place at a certain temperature, which dramatically increases the power production of the solar panel. As shown in electrical solar power graph 130, the electrical power generated by the solar panel increases as the temperature of the solar panel 830 is lowered by the cooling system 840. Additionally, the points in time when the electrical power produced by the solar panel dramatically increases due to the quantum effect is shown 140.

In one or more embodiments, the present invention may provide for an efficient system and method to both cool a solar panel in order to increase the efficiency of the solar panel, while simultaneously using the heat of the solar panel to warm pool water. This arrangement may help to improve the efficiency of photovoltaic panels by up to 20% while allowing water to be heated affordably and efficiently.

One or more embodiments of the present invention present systems and methods for solar panel temperature regulation that increase solar output and better utilize the “low grade” heat from the panels to effectively heat swimming pools and/or provide warm water for shower and baths. In a first embodiment a swimming pool is employed and a second embodiment does not use a swimming pool.

The Photovoltaic (PV) solar uptake (or energy usage or expense) for home-owners who have swimming pools is significantly higher than those without. One reason is because an average swimming pool owner uses about 30 KWh per day of electricity, which is far more than those without a swimming pool. The energy is used to perform at least one of running the pool filter pump for about 8 hours per day and/or heating the swimming pool.

Swimming pool owners may also use significant quantities of natural gas to heat their pool. Therefore, in one embodiment of the present invention where at least some heating of the pool is provided by heat from the solar panels, both decreased electricity costs and decreased natural gas usage and cost may be achieved.

Therefore, the financial return on investment to install the present solar system may be highly desirable for swimming pool owners in that it may reduce the energy investment required to heat and/or circulate the pool water.

In one embodiment, an overall cooling system may include one or more of the cooling systems 600. As shown above, the cooling system may be attached to the rear of a solar panel—and many solar panel installations include multiple solar panels. When multiple solar panels are each equipped with a cooling system, the water supplied to the cooling systems may be supplied in series or in parallel. For a series connection the pump 820 pumps water from the swimming pool 820 to the cool water delivery pipe 690 of a first cooling system and then the water passes from the warm water removal pipe 692 of the first cooling system into the cool water delivery pipe of a second cooling system, and so on.

Conversely, for a parallel connection, the pump 820 pumps water from the swimming pool 820 to the cool water delivery pipes 690 of each of the cooling systems and then receives warm water from the warm water removal pipe 692 of each cooling system.

Series cooling will tend be the proper choice in cooler climates because the system does not lose as much thermal efficiency since the delta temperatures between panels and coolant water is significant

In one embodiment, the heat transfer plate may be trimmed to maximize the surface area in contact with the solar panel.

In one embodiment, the heat transfer pipe may be composed of a metal, such as copper.

In one embodiment, the heat transfer pipe may be rectilinear or square in shape and the omega-shaped central channel may be replaced by a rectangular central channel to accommodate the rectilinear heat transfer pipe.

In one embodiment, the heat transfer plates may be weighed down with during the thermal epoxy curing process in order to remove air pockets and thus increase the efficiency of thermal transfer of the thermal epoxy. In one embodiment, bricks may be employed.

In one embodiment, by utilizing copper tubes, heat transfer plates and few other quick labor assembly parts like quick disconnects and thermal epoxy, with a cutout channel in the frame of the solar panel, electrical efficiency of solar panels can be improved while heating water.

In one embodiment, the system may include two modes of operations: 1. ultra-efficient mode—where electricity generation is favored over water heating, and 2. hot-water generation, where we still generate more electricity than without the thermal system, yet we heat water more effectively that Mode 1.

In one embodiment, when not using the pool, the user can select a mode of operation to emphasize electricity generation over water heating. By controlling a water pump with a low duty cycle of less than about 15%, the present system does not waste pump energy. Because of the “quantum solar effect” net electricity generation is maximized by just cooling the solar panel for a short period of time.

In one embodiment, even for hot water heating mode, this control system improves thermal quality. The system is capable of improving the thermal quality of a pool, or of the hot water usage inside the home by setting a pump duty cycle of less than about 67%.

In one embodiment, to save cost the system does not directly monitor the solar panels. Instead an ambient temperature sensor and light sensor will run a thermal model in software of the panels to determine the optimum duty cycle. On cold and cloudy days the pump will remain off. On the most sunny days, the pump duty will go to either a max of −15% or −67% depending on the User selected mode. The duty cycle will be linearly interpolated to a cold day by a function between −18 deg C. (zero duty) and −35 deg C. (max duty)

Cooled Solar PV without a Pool

Tank-less water heater systems are becoming popular for solar PV home owners. In these systems electricity is used to heat the water eliminating the need of a boiler and storage tank. Solar thermal systems have been around for a long time, but have not reached high market acceptance. One issue with a traditional solar thermal system is that it is not very efficient because it uses a recirculated system which pumps back unused warm water back to the panels.

In one embodiment of the invention, a tank is added and the electric geyser or hot water heater is linked to the system and provides hot water through the hot water supply. In operation, the tank is filled with warm water. The tank stores enough warm water for typical daily use. The electric geyser is used to supplement heat hot water. In one embodiment, the system is much more efficient that traditional solar thermal systems because it preferably continuously flows cool water over the solar panels. Thermal efficiency is a function of delta temperature. Where the higher the delta T, the more thermal energy may be absorbed.

If there is no hot water available, then the system operates similarly to a traditional tank-less water heater system. The controller in the system above works by measuring the water level in the tank using a fuel gauge and temperature of the cold plate or solar panels. If the tank is empty or panels are cool than the valve, such as a solenoid valve is controlled to directly tap cold water to the hot water supply where it will be heated by the geyser as in a traditional system. If solar panels are warm or the tank is not full than the water supply is directed to the heat plate. When the valve such as a solenoid valve is switched to flow water into the storage tank, the pump is turned on to facilitate effective heat exchange.

By adding a smart controller and a water tank to a traditional tank-less system a tremendous amount of efficiency is gained.

In one embodiment, the present invention may use a non-pool system using a tank that is only filled with hot water. This saves recirculation energy used in typical thermal control systems of the past.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A solar panel cooling system including:
a heat transfer plate having a central channel; and
a heat transfer pipe disposed in said central channel and thermally bonded to said heat transfer plate,
wherein said heat transfer plate and said heat transfer pipe are thermally bonded to the rear side of a solar panel,
wherein water is induced to flow through said heat transfer pipe, wherein said water is in thermal communication with said solar panel and acts to cool said solar panel.

2. The system of claim 1 further including a plurality of heat transfer plates and heat transfer pipes.

3. The system of claim 1 further including a solar panel housing surrounding said solar panel.

4. The system of claim 3 wherein said solar panel housing includes a heat transfer pipe input aperture through which said heat transfer pipe extends.

5. The system of claim 3 wherein said solar panel housing includes a heat transfer pipe output aperture through which said heat transfer pipe extends.

6. The system of claim 3 wherein said solar panel housing includes insulation positioned on the exterior of said heat transfer plate.

7. The system of claim 1 further including a pump pumping said water through said heat transfer pipe.

8. The system of claim 7 further including a controller controlling said pump.

9. The system of claim 7 further including a temperature sensor, wherein said temperature sensor transmits temperature information to said controller.

10. The system of claim 9 wherein said controller compares said temperature information to a preset temperature trigger point.

11. The system of claim 10 wherein said controller and activates said pump when said temperature information exceeds said preset trigger point.

12. The system of claim 7 wherein said pump pumps said water from a swimming pool.

13. A method for cooling a solar panel, said method including:
positioning a heat transfer pipe in a central channel of a heat transfer plate;
thermally bonding said heat transfer pipe to said heat transfer plate;
thermally bonding said heat transfer pipe and said heat transfer plate to a solar panel; and
inducing water to flow through said heat transfer pipe wherein said water is in thermal communication with said solar panel and acts to cool said solar panel.

14. The method of claim 13 wherein said water is induced to flow through said heat transfer pipe using a pump.

15. The method of claim 14 wherein said pump is controlled by a controller.

16. The method of claim 15 wherein said controller receives temperature information from a temperature sensor.

17. The method of claim 16 wherein said controller compares said temperature information to a preset temperature trigger point.

18. The method of claim 17 wherein said controller and activates said pump when said temperature information exceeds said preset trigger point.

19. The method of claim 14 wherein said pump pumps said water from a swimming pool.
